(19) United States
(12) Patent Application Publication
(10) Pub. No.: US 2025/0310771 A1
(43) Pub. Date: Oct. 2, 2025

(54) SECURITY IN COMMUNICATION NETWORKS

(71) Applicant: Nokia Solutions and Networks Oy, Espoo (FI)

(72) Inventors: Majed JADAYEL, Ottawa (CA); Kevin MCNAMEE, Ottawa (CA)

(21) Appl. No.: 18/873,559

(22) PCT Filed: Jun. 22, 2022
(86) PCT No.: PCT/FI2022/050453

§ 371 Date: Dec. 10, 2024

(51) Int. Cl. H04W 12/121

(52) U.S. Cl. CPC H04W 12/121

(57) ABSTRACT

According to an example aspect of the present disclosure, there is provided a method, comprising determining, by an apparatus, a base score of a network entity, wherein the base score indicates importance of the network entity in a network, determining, by the apparatus, a dynamic score of the network entity, wherein the dynamic score indicates at least security incidents that have happened to the network entity, determining, by the apparatus, a threat score of the network entity based at least on the base score and the dynamic score and determining, by the apparatus, based on the threat score, whether to perform an action associated with the network entity.

### FIELD

Various example embodiments relate in general to communication networks and more specifically, to security in such systems.

### BACKGROUND

Security is important in various communications in general, such as in cellular communication systems, like in 5G networks developed by the 3rd Generation Partnership Project, 3GPP. The 3GPP still develops 5G networks and there is a need to provide improved methods, apparatuses and computer programs for enhancing security of 5G networks. Such enhancements may be exploited in other cellular communication networks as well. For example, such enhancements may be exploited in 6G networks in the future.

### SUMMARY

According to some aspects, there is provided the subject-matter of the independent claims. Some embodiments are defined in the dependent claims. The scope of protection sought for various embodiments of the disclosure is set out by the independent claims. The embodiments, examples and features, if any, described in this specification that do not fall under the scope of the independent claims are to be interpreted as examples useful for understanding various embodiments of the disclosure.

According to a first aspect of the present disclosure, there is provided an apparatus comprising at least one processing core, at least one memory including computer program code, the at least one memory and the computer program code being configured to, with the at least one processing core, cause the apparatus at least to determine a base score of a network entity, wherein the base score indicates importance of the network entity in a network, determine a dynamic score of the network entity, wherein the dynamic score indicates at least security incidents that have happened to the network entity, determine a threat score of the network entity based at least on the base score and the dynamic score and determine, based on the threat score, whether to perform an action associated with the network entity.

According to a second aspect of the present disclosure, there is provided a method comprising, determining, by an apparatus, a base score of a network entity, wherein the base score indicates importance of the network entity in a network, determining, by the apparatus, a dynamic score of the network entity, wherein the dynamic score indicates at least security incidents that have happened to the network entity, determining, by the apparatus, a threat score of the network entity based at least on the base score and the dynamic score and determining, by the apparatus, based on the threat score, whether to perform an action associated with the network entity.

According to a third aspect of the present disclosure, there is provided an apparatus comprising means for determining a base score of a network entity, wherein the base score indicates importance of the network entity in a network, means for determining a dynamic score of the network entity, wherein the dynamic score indicates at least security incidents that have happened to the network entity, means for determining a threat score of the network entity based at least on the base score and the dynamic score and means for determining, based on the threat score, whether to perform an action associated with the network entity.

According to a fourth aspect of the present disclosure, there is provided a non-transitory computer readable medium having stored thereon a set of computer readable instructions that, when executed by at least one processor, cause an apparatus to at least to perform the method. According to an fifth aspect of the present disclosure, there is provided a computer program comprising instructions which, when the program is executed by an apparatus, cause the apparatus to carry out the method.

### BRIEF DESCRIPTION OF THE DRAWINGS

FIG. 1 illustrates an example of threat score calculation in accordance with at least some embodiments of the present disclosure;

FIG. 2 illustrates a first signalling graph in accordance with at least some embodiments of the present disclosure;

FIG. 3 illustrates an example apparatus capable of supporting at least some embodiments of the present disclosure;

FIG. 4 illustrates a first example of propagation in accordance with at least some embodiments of the present disclosure;

FIG. 5 illustrates a second example of propagation in accordance with at least some embodiments of the present disclosure;

FIG. 6 illustrates an example of an incident notification application in accordance with at least some embodiments of the present disclosure;

FIG. 7 illustrates a second signalling graph in accordance with at least some embodiments of the present disclosure;

FIG. 8 illustrates a flow graph of a method in accordance with at least some embodiments of the present disclosure;

FIG. 9 illustrates an example of base scores in accordance with at least some embodiments of the present disclosure.

### EMBODIMENTS

Embodiments of the present disclosure provide security enhancements communication networks. More specifically, embodiments of the present disclosure provide enhancements for security in cellular communication networks, such as in 5G core networks or 6G networks in the future, by providing a way to calculate a threat score for each network entity to take into account static, or relatively static, parameters together with dynamic parameters. The threat score may be calculated by multiplying a base score with a dynamic score for a network entity, wherein the base score indicates importance of the network entity in the network and the dynamic score indicates at least security incidents that have happened to the network entity. After that it may be determined, based on the threat score, whether an action is needed and if so, a timing of the action and the action itself. Thus, it is possible to enhance security of the network by performing the correct action at the right time, when needed, but unnecessary actions can be avoided.

The threat score may be calculated for each entity in the network and it may be a numeric value that tells, e.g., to an operator of a cellular communication network, how likely an entity is to be a victim of a successful attack. Alternatively, or in addition, the threat score may be proportional to the damage that could be caused by the attack. The threat score may be used to prioritize actions of a system operator of the cellular communication network and trigger automated actions when appropriate. In some example embodiments, the threat score may be presented visually on a display of a network topology to highlight the network entities that are at high risk and need operator attention.

Embodiments of the present disclosure therefore enable dynamic real-time assessment of the risk to the network entity based on for example a type of a network entity, like a Network Function, NF, its importance to correct operation of the network its security posture in terms of vulnerabilities, recent attacks and exploit attempts on the entity itself and recent attacks and/or malicious activity in its network neighbourhood. Moreover, at least one of the following factors may be considered when calculating the threat score for a network entity:
a base score, which may be calculated from what the entity is and does. The base score may be used as a multiplier in the threat score calculation. The base score may indicate at least importance of the network entity in a network and comprise for example information about the likelihood of the attack towards the network entity and a level of damage that would be caused to the network as a result of an attack;
a dynamic score, which may indicate at least security incidents that have happened to the network entity. For instance, the dynamic score may indicate active security incidents that apply to the network entity and make up the dynamic aspect of the threat score. The dynamic score may be determined, e.g., from security logs or as a result of behavioural analysis. The dynamic score may indicate if the network entity is being scanned, probed or accessed in any suspicious way or has new vulnerabilities that need to be addresses. The system may continue working even if some low level security incidents would occur. Different types and frequencies of security incidents may be considered in deriving the dynamic score, which in turn contributed to the threat score;
in some example embodiments, the threat score may be further based on active or failed remediation action applied to network entities, e.g., negatively affected if the network entity has failed remediation attempts or multiple remediation actions applied in short period of time.

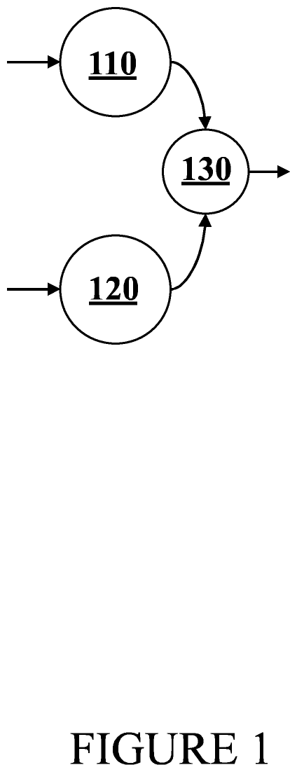

FIG. 1 illustrates an example of threat score calculation in accordance with at least some embodiments of the present disclosure. In FIG. 1, base score is denoted by 110, dynamic score is denoted by 120 and threat score is denoted by 130.

Base score 110 may be calculated from what the entity is and does. The input of base score 110 may comprise a type of the network entity, such as a type of a NF when the network is a Core, Radio Access Network, RAN, or Transport network segment of a cellular communication network, like 5G or 6G, and/or security hardening. Security hardening may for example refer to a configuration of the network entity. Thus, an apparatus may be configured to determine the base score of the network entity based on the type of the network entity and/or the configuration of the network entity.

An apparatus may be configured to determine base score 110 of the network entity, wherein base score 110 indicates importance of the network in the network. For instance, base score 110 may be set by a human operator and in such a case the apparatus may be configured to determine base score 110 from an input received from the human operator. Alternatively, the apparatus may be configured to determine base score 110, e.g., from information received from another apparatus in the network or from a standard.

The input of dynamic score 120 may comprise active security incidents, security audits, assessed vulnerabilities, remediation actions accessive/failure and/or Machine Learning, ML, security anomalies. Thus, an apparatus may be configured to determine the dynamic score for the network entity, e.g., based at least one of a number security incidents that have happened to the network entity, a number of vulnerabilities and/or a number of anomalies.

An apparatus may be configured to determine threat score 130 based at least on base score 110 and dynamic score 120. For instance, base score 110 may be multiplied with dynamic score 120 to generate threat score 130 for the network entity. The output of threat score 130 may be for example an estimation of a likelihood of the network entity being a victim to a successful attack (0≤TS≤100).

In some example embodiments, numeric values may be assigned to threat score 130, and the following color-coded scheme may be used to display threat score on a User Interface, UI:
Green: Low risk→No action required;
Yellow: Moderate risk→Fix with scheduled maintenance;
Orange: High risk→Fix as soon as possible;
Red: Critical risk→Immediate action required;
Grey: Unknown risk→Entity not under security monitoring.

An apparatus may be configured to display a coloured sign, such as green, yellow, orange, red or grey, based on the threat score. The UI may be used to report threat score 130 for individual network entities and/or a group of entities, for example, at a network type level. In that case the highest threat score of the underlying network entities may be the threat score on the group level. The UI may be in the form of a network map with the network entities grouped by a subnet and/or a function. Another option may be to list network entities in the order of threat score 130. Clicking on threat score 130 or a network entity may provide details as to why the score has been assigned and provide specifics on how it may be improved.

Threat score 130 and any associated information with it may be stored for each network entity in the same database that holds topology data of the network, like a cellular communication network. Re-calculations of threat score 130 may be triggered by at least one of the following changes:
a topology system may inform the apparatus, which is configured to generate threat score 130, when an entity is added, deleted or modified. The topology system may provide an entity identifier and the reason for the trigger. For new entities, the apparatus may be configured to create a new entry in the threat score database and calculate its score. This new score may impact scores for network entities higher in the hierarchy. If the trigger is a deletion, the apparatus may be configured to mark the network entity as deleted in the threat score database and update the scores higher in the hierarchy. The modify trigger may be used to update information in the threat score database as required;
base score 110 may change and in such a case a trigger may provide a type of the network entity for which base score 110 has changed and the new base score. The apparatus configured to generate threat score 130 may go through the threat score database and recalculate the scores of network entities of the same type, i.e., network entities with the provided type for which base score 110 has changed;
an incident trigger may comprise an entity identity of the impacted network entity. The apparatus configured to generate threat score 130 use an incident Application Programming Interface, API, to walk through all incidents associated with that identity and recalculate threat score 130 of all network entities associated with such incidents;
any increase or decrease in the total of active remediation actions may trigger re-calculation of threat score 130. For instance, if accessive random access failed to remediate an incident, threat score 130 may be impacted negatively;
ML Security anomalies, like new positive security anomalies and User and Entity Behaviour Analytics, UEBA, anomalies may be used to trigger re-calculations of threat score 130 once these anomalies are translated to open active incidents.

In some example embodiments, threat score 130, i.e., TS, may be calculated using the following equation:

$$T S = B S * D S , \qquad ( 1 )$$

wherein BS is base score 110 and DS is dynamic score 120. Dynamic score 120, i.e., DS, may be further calculated using the following equation:

$$D S = {\sum }_{i} {I}_{i} + {\sum }_{j} {V}_{j} + ( {\sum }_{k} M L {A}_{k} + {\sum }_{l} {A}_{l} ) * 0.5 , \qquad ( 2 )$$

wherein I denotes a dynamic threat score from incidents, V denotes a dynamic threat score from vulnerabilities, MLA denotes a dynamic threat score from anomalies and A denotes a dynamic threat score from alerts. Note that the multiplier of 0.5 may be used to factor in the false positives in the number of anomalies and alerts. Alerts may be used in Equation (2) if there are any generated from an Extended Detection and Response, XDR, against the network entity.
In some example embodiments, the following table may be used to map threat scores 130, TS, to colours and actions. If threat score 130 is greater than 100, it may be set to 100.

TABLE 1
Mapping table

| | | Threat | |
|---|---|---|---|
| Score | Color | Level | Action |
| 0-29 | Green | Low | No action required |
| 30-59 | Yellow | Moderate | Fix with scheduled |
| | | | maintenance |
| 60-99 | Orange | High | Fix as soon as possible |
| 100 | Red | Critical | Immediate action required |

As an example, if a network entity has a base score of 8 because it is a high value entity with sensitive data, the threat score for one high severity incident will be 80, which would be regarded as a high threat. Two moderate threats would give the same score, as would five low threats. Anything over 100 would be critical. The actual algorithm and the values assigned to the incident severities may be adjusted based on experience prior to releasing a product to make sure alarms and actions are appropriate.

The apparatus configured to calculate threat score 130 may be hence configured to determine, when it is determined that an action is to performed, a timing of the action, wherein the timing of the action comprises scheduled maintenance, as soon as possible and immediate.

In some embodiments, the apparatus configured to calculate threat score 130 may be configured to change, when it is determined that an action is to be performed and the action is fix with scheduled maintenance, a configuration of the network entity. For instance, If a network function has a major incident open against it with remediation action of increase configured security parameters, if this incident severity level is changed from Critical to major, the threat score would get re-calculated and would decrease in this case since this incident is determined to not be FIX NOW incident.

In some embodiments, the apparatus configured to calculate threat score 130 may be configured to run, when it is determined that an action is to be performed and the action is fix as soon as possible, a malware and/or anti-virus program. For instance, if a network function has a major incident open against it with remediation action to be executed as soon as possible, if this incident severity level is changed from major to critical, the threat score would get re-calculated and would increase in this case since this incident is determined to be FIX NOW incident.

In some embodiments, the apparatus configured to calculate threat score 130 may be configured to configure, when it is determined that an action is to be performed and the action is fix immediately, a firewall of the network entity to block all traffic. For instance, if a network function has a major incident open against it with remediation action to be executed as soon as possible, if this incident severity level is changed from major to critical, the threat score would get re-calculated and would increase in this case since this incident is determined to be FIX NOW incident.

In some example embodiments, threat score 130 may change. In such a case, the apparatus configured to calculate threat score 130 may be configured to determine another base score of the network entity, wherein said another base score replaces base score 130 of the network entity and determine another threat score of the network entity based at least on said another base score and the dynamic score. Said another threat score may then replace threat score 130 and be used similarly.

Severity sum may be a sum of severity of all incidents for a given network entity. For instance, each incident or alert associated with a network entity may have a severity level assigned by a XDR layer. For instance, the following table may be used.

TABLE 2
Severity table

| Network element | Severity | Score |
|---|---|---|
| PCF | High | 10 |
| UPF | Moderate | 5 |
| SMF | Low | 2 |
| NRF | High | 6 |

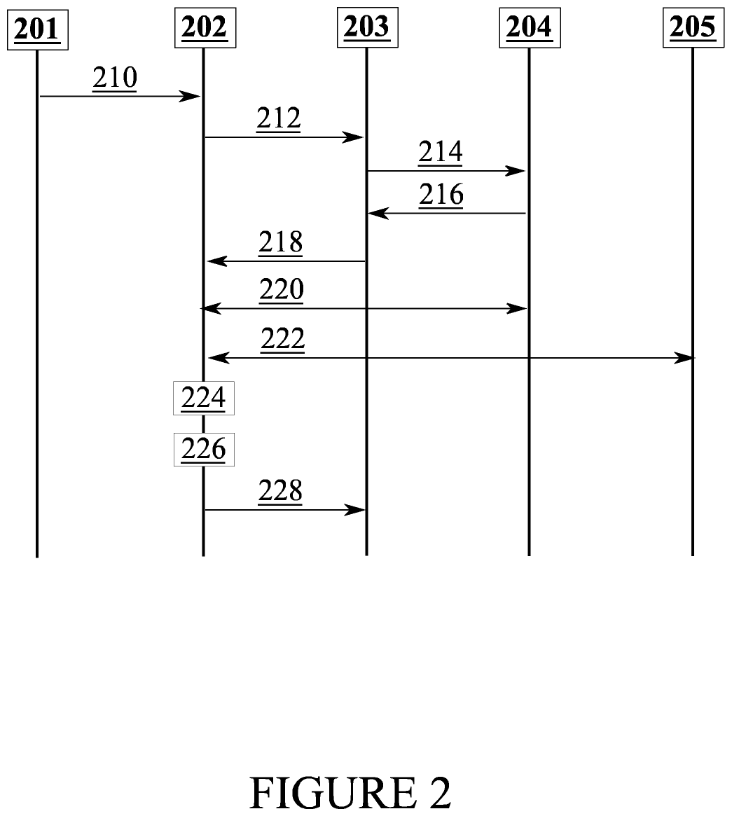

FIG. 2 illustrates a first signalling graph in accordance with at least some embodiments of the present disclosure. In FIG. 2, XDR is denoted by 201, threat score service/apparatus is denoted by 202, topology service/apparatus is denoted by 203, database (e.g., CosmoDB) is denoted by 204 and incident groups/entities are denoted by 205.

At step 210, XDR may transmit a request to update threat score 130 of a network entity (updateThreatScore (name)). At step 212, threat score service/apparatus 202 may transmit a request for information about the network entity (topologyLayer (name)). At step 214, topology service/apparatus 203 may transmit a dispatch request and at step 216, database 204 may respond to the dispatch request by transmitting said information about the network entity, and possibly upper information about upper layers as well. At step 218, topology service/apparatus 203 may transmit the received information to threat score service/apparatus 202. At step 220, threat score service/apparatus 202 may transmit a request to get base score 110 of the network entity (getBaseScore (objectType, entityType)) and database 204 may return base score 110 of the network entity.

Steps 222-228 may be optional. At step 222, threat score service/apparatus 202 may, if base score 110 exists, transmit a request for incidents to incident groups/entities 205 (incidentsByEntity (name)) and incident groups/entities 205 may return the incidents, possibly with severity. At step 224, threat score service/apparatus 202 may calculate threat 130 for the network entity (calculateThreatScoreForEntity (baseScore, incidents)). At step 226, threat score service/apparatus 202 may update threat score 130 for ancestors of the network entity (updateThreatScoreFor Ancestors (calculatedThreatScoreForEntity, ancestorsHierarchy)). At step 228, threat score service/apparatus 202 may update the topology for each network entity (updateTopologyObjectMetrics (name: String, metrics: MetricsInput)). Updating of all entities may be performed by sending a list of metrics and it may require changes in endpoint to accept the list of metrics.

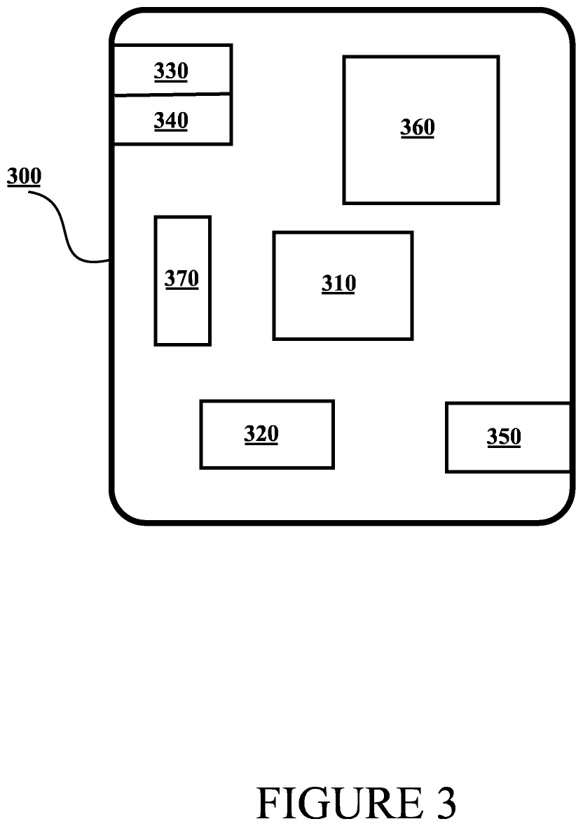

FIG. 3 illustrates an example apparatus capable of supporting at least some example embodiments. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions. Device 330 may be an apparatus configured to calculate threat score 130.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with Global System for Mobile communication, GSM, Wideband Code Division Multiple Access, WCDMA, Long Term Evolution, LTE, and/or 5G/NR standards, for example.

Device 300 may comprise a Near-Field Communication, NFC, transceiver 350. NFC transceiver 350 may support at least one NFC technology, such as Bluetooth, Wibree or similar technologies.

Device 300 may comprise User Interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a Subscriber Identity Module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some example embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the example embodiment various ways of interconnecting at least two of the aforementioned devices may be selected without departing from the scope of the example embodiments.

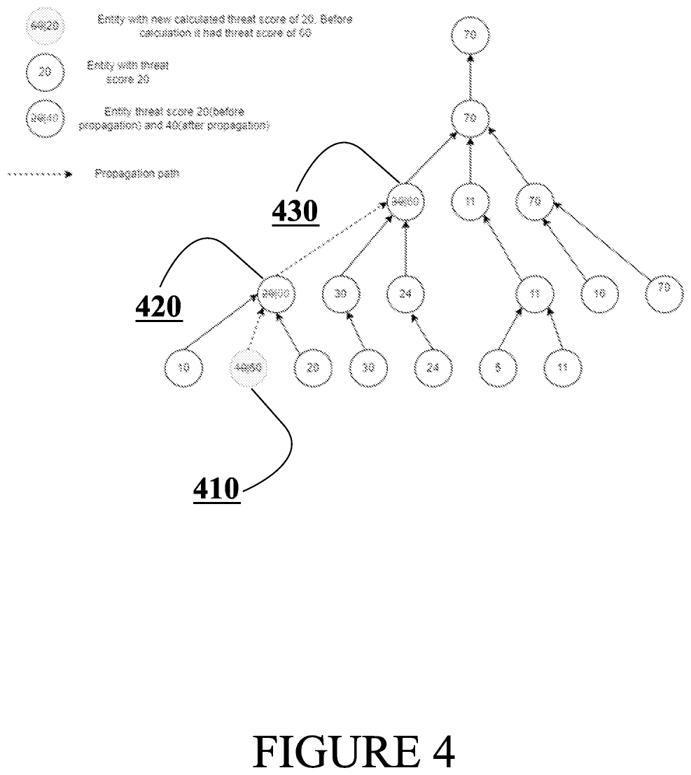

FIG. 4 illustrates a first example of propagation in accordance with at least some embodiments of the present disclosure. More specifically, FIG. 4 illustrates how threat score 130 may be propagated from a first, lowest level to higher levels. In FIG. 4, first level network entity is denoted by 410, second level network entity is denoted by 420 and third level network entity is denoted by 430.

The first example of propagation is an example wherein calculated threat score 130 is higher than a previous value, e.g., in case of first level network entity 410. This may happen for example when new incident for a network entity has been created. Threat score 130 of one network entity, like first level network entity 410, is a value for that entity but without propagation it would not reflect the impact on other network elements in the same network, like second level network entity 420 and/or third level network entity 430. In order to take into account the impact, threat score 130 may be propagated from the lowest level up to the root of the network. For instance, threat score 130 of first level network entity 410, “X”, may be propagated to second level network entity 420, “Z”, and further to third level network entity 430, “W”, and so forth.

With reference to FIG. 2, in some example embodiments, threat score service/apparatus 202 may receive a request on updateThreatScore endpoint to calculate threat score 130 for an entity with name “X”. Entity type for entity “X” is “A”. Base score 110 for entity type “A” may exists in database 204. Threat score 130 for entity “X” may be calculated and calculated threat score 130 may become new threat score for entity “X”.

If entity “X” has parent entity “Z”, the propagation may start. Propagated threat score may be a highest value between a threat score value that comes from children that propagated value come from (in this case entity “X”) or a highest threat score value between all children (excluding entity “X”) of parent “Z”. If entity “Z” has parent entity “W”, the propagation may continue and propagated threat score 130 may be a highest value between threat score 130 that comes from children that propagated value come from (in this case entity “Z”) or a highest threat score value between all children (excluding entity “Z”) of parent “W”. The propagation may be continued until there is no parent for a network entity.

Thus, the apparatus, like apparatus 300, configured to calculate threat score 130 may be configured to determine that the network entity has a parent network entity and determine a threat score of the parent network entity, like 420, based on the threat score of the network entity, like 410. For instance, the apparatus, like apparatus 300, configured to calculate threat score 130 may be configured to determine the threat score of the parent network entity, like 420, as equal or bigger than the threat score of the network entity when a previous threat score of the parent network entity is lower than the threat score of the network entity.

Equivalently, as a skilled person understands, the score(s) may indicate seriousness of threats in other direction. That is, another equivalent implementation may be to set the score(s) such that a smaller score indicates more serious threat(s). In such a case, the apparatus, like apparatus 300, configured to calculate threat score 130 may be configured to determine the threat score of the parent network entity, like as equal or smaller than the threat score of the network entity when a previous threat score of the parent network entity is higher than the threat score of the network entity.

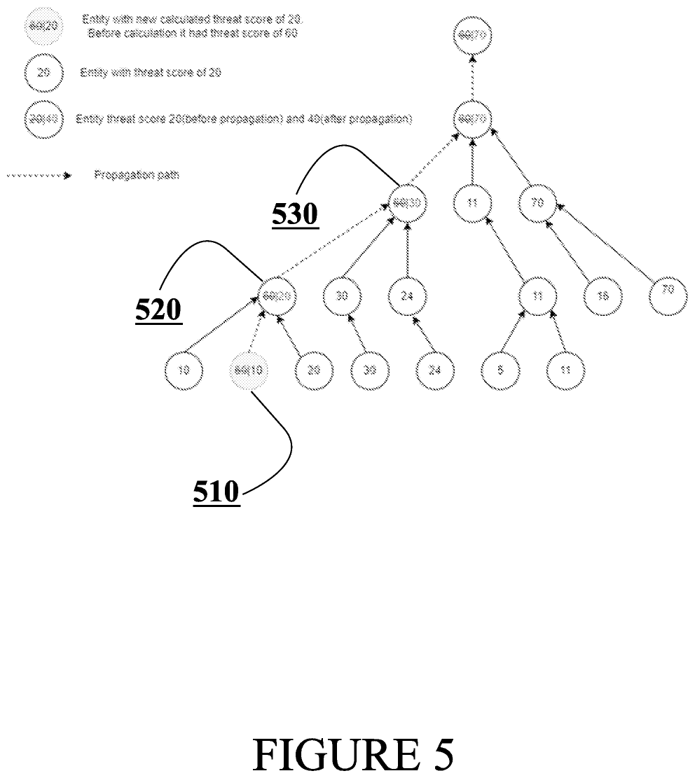

FIG. 5 illustrates a second example of propagation in accordance with at least some embodiments of the present disclosure. More specifically, FIG. 5 illustrates how threat score 130 may be propagated from a first, lowest level to higher levels. In FIG. 5, first level network entity is denoted by 510, second level network entity is denoted by 520 and third level network entity is denoted by 530.

The first example of propagation is an example wherein calculated threat score 130 is lower than a previous value, e.g., in case of first level network entity 410. This may happen for example when an incident for a network entity has been resolved.

Thus, the apparatus, like apparatus 300, configured to calculate threat score may be configured to determine that the network entity has a parent network entity and determine a threat score of the parent network entity, like 520, based on the threat score of the network entity, like 510. For instance, the apparatus, like apparatus 300, configured to calculate threat score 130 may be configured to determine the threat score of the parent network entity, like 520, as equal or bigger than a threat score of another network entity when the threat score of said another network entity is higher than the threat score of the network entity.

Equivalently, as a skilled person understands, the score(s) may indicate seriousness of threats in other direction. That is, another equivalent implementation may be to set the score(s) such that a smaller score indicates more serious threat(s). In such a case, the apparatus, like apparatus 300, configured to calculate threat score 130 may be configured to determine the threat score of the parent network entity, like 520, as equal or smaller than a threat score of another network entity when the threat score of said another network entity is higher than the threat score of the network entity.

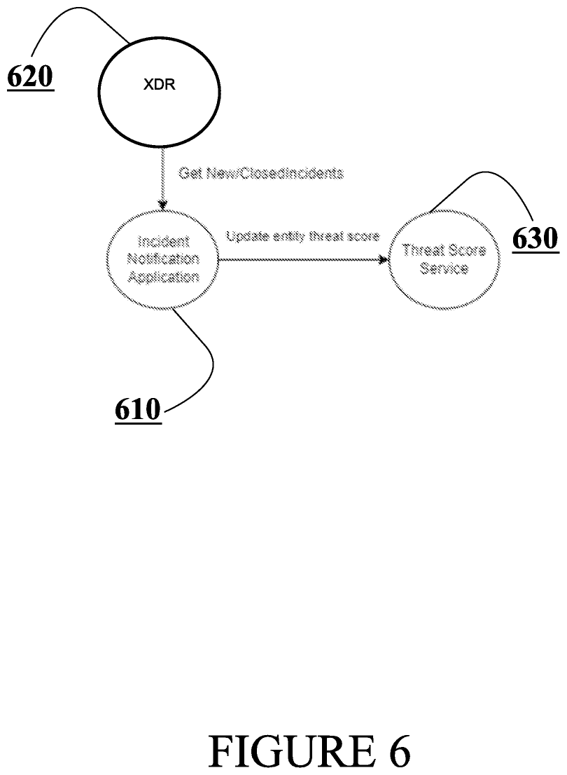

FIG. 6 illustrates an example of an incident notification application in accordance with at least some embodiments of the present disclosure. In FIG. 6, incident notification application is denoted by 610, XDR is denoted by 620 and threat score service is denoted by 630. XDR 620 may correspond to XDR 201 and threat score service 630 may correspond to threat score service/apparatus 202 of FIG. 2.

To update threat score 130 for all the entities related to incidents, there may be a requirement to notify the threat score service when an incident is created or closed. Incident notification application 610 may periodically poll all new or closed incident(s) and notify threat score service 630 to update threat score 130 of the related entities. At the time of the start-up, incident notification application 610 may read all open incidents, notify threat score service 630 and save the timestamp. Incident notification application 610 may then poll all open and closed incidents and notify threat score service 630. The new timestamp may be saved and used as the start time for the next polling. It may be required to save the timestamp every cycle to keep track of the timestamp in case the application is restarted.

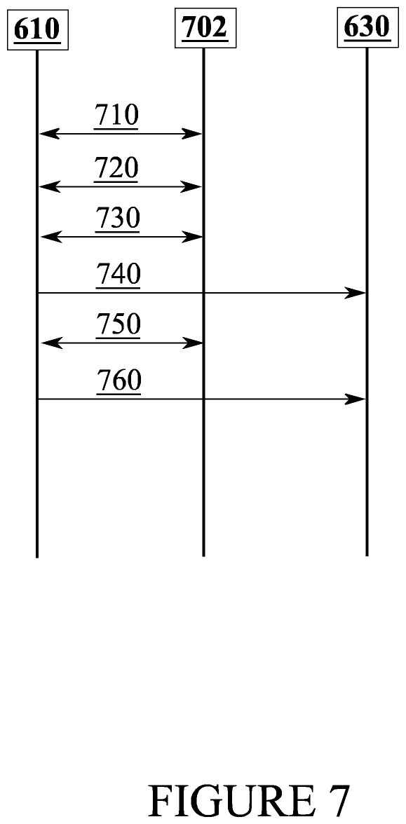

FIG. 7 illustrates a second signalling graph in accordance with at least some embodiments of the present disclosure. In FIG. 7, incident notification application 610 and threat score service 630 are shown together with XDR system 702.

At step 710, incident notification application 610 may transmit a request to XDR system 702, to request new incidents and XDR system 702 may respond by transmitting a list of new incidents. At step 720, incident notification application 610 may transmit another request to XDR system 702, to request closed incidents and XDR system 702 may respond by transmitting a list of closed incidents. For each new incident, incident notification application 610 may, at step 740, transmit a request to XDR system 702, to request an incident entity and XDR system 702 may respond by transmitting the entity. At step 740, incident notification application 610 may transmit an update threat score to threat score service 630 ((updateThreatScore (incident entity)).

For each closed incident, incident notification application 610 may, at step 750, transmit a request to XDR system 702, to request an incident entity and XDR system 702 may respond by transmitting the entity. At step 760, incident notification application 610 may transmit an update threat score to threat score service 630 ((updateThreatScore (incident entity)).

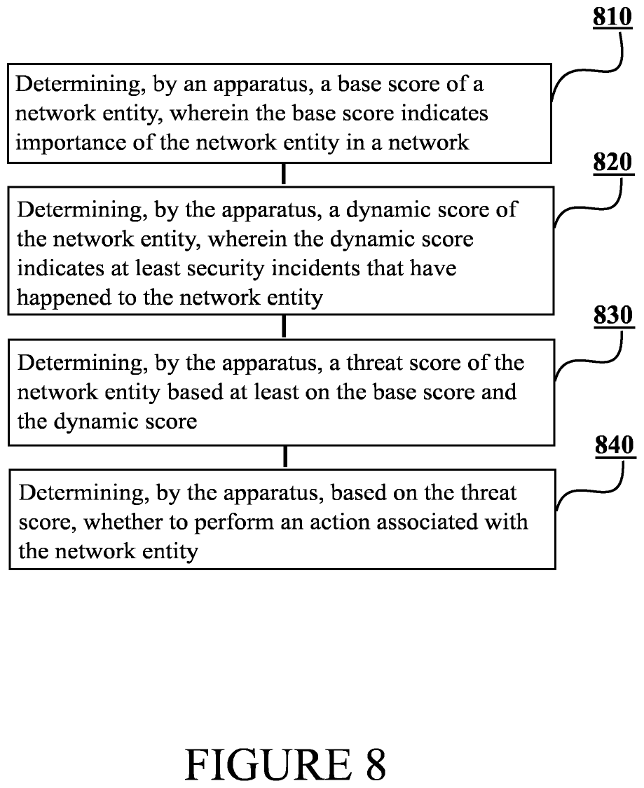

FIG. 8 is a flow graph of a method in accordance with at least some embodiments of the present disclosure. The phases of the illustrated method may be performed by apparatus 300 for example.

The method may comprise, at step 810, determining, by an apparatus, a base score of a network entity, wherein the base score indicates importance of the network entity in a network. The method may further comprise, at step 820, determining, by the apparatus, a dynamic score of the network entity, wherein the dynamic score indicates at least security incidents that have happened to the network entity. The method may also comprise, at step 830, determining, by the apparatus, a threat score of the network entity based at least on the base score and the dynamic score. Finally, the method may comprise, at step 840, determining, by the apparatus, based on the threat score, whether to perform an action associated with the network entity.

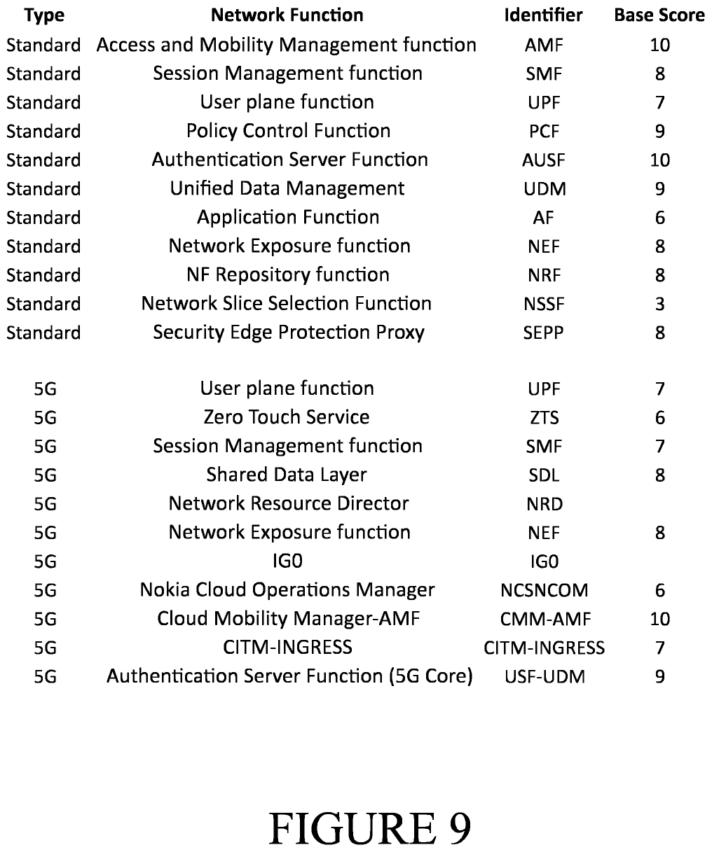

FIG. 9 illustrates an example of base scores in accordance with at least some embodiments of the present disclosure. Embodiments of the present invention are particularly beneficial in core networks of cellular communication networks, like in 5G networks developed by the 3rd Generation Partnership Project, 3GPP, or in 6G networks in the future. In such networks the network entities may be NFs and there may be various NFs. Related to security, the importance of an NF may vary depending a type. As shown in FIG. 9, and with reference to FIG. 1, NFs with different identifiers may have different base scores 110. Base score value 10 may for example indicate that an attack to that NF would be extremely harmful to the network while an attack to an NF with a lower base score value would be less harmful.

It is to be understood that the embodiments of the disclosure disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the disclosure. One skilled in the relevant art will recognize, however, that the disclosure can be practiced without one or more of the specific details, or with other methods, components, materials, etc. In other instances, well-known structures, materials, or operations are not shown or described in detail to avoid obscuring aspects of the disclosure.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in communication networks, for example in cellular communication networks, such as 3GPP networks.

ACRONYMS LIST

| | |
|---|---|
| 3GPP | 3rd Generation Partnership Project |
| API | Application Programming Interface |
| GPS | Global Positioning System |
| LTE | Long Term Evolution |
| ML | Machine Learning |
| NF | Network Function |
| NR | New Radio |
| RAN | Radio Access Network |
| UE | User Equipment |
| UEBA | User and Entity Behaviour Analytics |
| WiMAX | Worldwide interoperability for Microwave Access |
| WLAN | Wireless Local Area Network |
| XDR | Extended Detection and Response |

REFERENCE SIGNS LIST

| | |
|---|---|
| 110 | Base score |
| 120 | Dynamic score |
| 130 | Threat score |
| 201, 620 | XDR |
| 202, 630 | Threat score service/apparatus |
| 203 | Topology service/apparatus |
| 204 | Database |
| 205 | Incident Groups/entities |
| 210-228 | Steps in the graph of FIG. 2 |
| 300-370 | Structure of the device of FIG. 3 |
| 410, 510 | 1^{st} level network entity |
| 420, 520 | 2^{nd} level network entity |
| 430, 530 | 3^{rd} level network entity |
| 610 | Incident notification application |
| 702 | XDR system |
| 710-760 | Steps in the graph of FIG. 7 |
| 810-840 | Phases of the method of FIG. 8 |

1-30. (canceled)

31. An apparatus comprising at least one processing core, at least one memory including computer program code, the at least one memory and the computer program code being configured to, with the at least one processing core, cause the apparatus at least to:
determine a base score of a network entity, wherein the base score indicates importance of the network entity in a network, and the network is a core network of a cellular communication network, and the network entity is a network function;
determine a dynamic score of the network entity, wherein the dynamic score indicates at least security incidents that have happened to the network entity;
determine a threat score of the network entity based at least on the base score and the dynamic score; and
determine, based on the threat score, whether to perform an action associated with the network entity.

32. The apparatus according to claim 31, wherein the base score further indicates a likelihood of an attack towards the network entity and/or a level of damage that would be caused to the network as a result of an attack to the network entity.

33. The apparatus according to claim 31, wherein the at least one memory and the computer program code are further configured to, with the at least one processing core, cause the apparatus at least to:
determine the base score of the network entity based on a type of the network entity, a configuration of the network entity and/or an amount of other network functions the network entity communicates with.

34. The apparatus according to claim 31, wherein the at least one memory and the computer program code are further configured to, with the at least one processing core, cause the apparatus at least to:
determine the dynamic score of the network entity based on at least one of a number security incidents that have happened to the network entity, a number of vulnerabilities, a number of anomalies and a number of alerts.

35. The apparatus according to claim 31, wherein the at least one memory and the computer program code are further configured to, with the at least one processing core, cause the apparatus at least to:
determine, when it is determined that an action is to performed, a timing of the action, wherein the timing of the action comprises scheduled maintenance, as soon as possible and immediate.

36. The apparatus according to claim 31, wherein the at least one memory and the computer program code are further configured to, with the at least one processing core, cause the apparatus at least to:
change, when it is determined that an action is to be performed and the action is fix with scheduled maintenance, a configuration of the network entity;
run, when it is determined that an action is to be performed and the action is fix as soon as possible, a malware and/or anti-virus program; and/or
configure, when it is determined that an action is to be performed and the action is fix immediately, a firewall of the network entity to block all traffic.

37. The apparatus according to claim 31, wherein the at least one memory and the computer program code are further configured to, with the at least one processing core, cause the apparatus at least to:
determine that the network entity has a parent network entity in hierarchy of the network; and
determine a threat score of the parent network entity based on the threat score of the network entity.

38. The apparatus according to claim 37, wherein the at least one memory and the computer program code are further configured to, with the at least one processing core, cause the apparatus at least to:
determine the threat score of the parent network entity as equal or bigger than the threat score of the network entity when a previous threat score of the parent network entity is lower than the threat score of the network entity.

39. The apparatus according to claim 37, wherein the at least one memory and the computer program code are further configured to, with the at least one processing core, cause the apparatus at least to:
determine the threat score of the parent network entity as equal or bigger than a threat score of another network entity when the threat score of said another network entity is higher than the threat score of the network entity.

40. The apparatus according to claim 31, wherein the at least one memory and the computer program code are further configured to, with the at least one processing core, cause the apparatus at least to:
determine another base score of the network entity, wherein said another base score replaces the base score of the network entity; and
determine another threat score of the network entity based at least on said another base score and the dynamic score.

41. The apparatus according to claim 40, wherein the at least one memory and the computer program code are further configured to, with the at least one processing core, cause the apparatus at least to:
display a coloured sign based on the threat score.

42. A method, comprising:
determining, by an apparatus, a base score of a network entity, wherein the base score indicates importance of the network entity in a network, and the network is a core network of a cellular communication network, and the network entity is a network function;
determining, by the apparatus, a dynamic score of the network entity, wherein the dynamic score indicates at least security incidents that have happened to the network entity;
determining, by the apparatus, a threat score of the network entity based at least on the base score and the dynamic score; and
determining, by the apparatus, based on the threat score, whether to perform an action associated with the network entity.

43. The method according to claim 42, wherein the base score further indicates a likelihood of an attack towards the network entity and/or a level of damage that would be caused to the network as a result of an attack to the network entity.

44. The method according to claim 42, further comprising:
determining, by the apparatus, the base score of the network entity based on a type of the network entity, a configuration of the network entity and/or an amount of other network functions the network entity communicates with.

45. The method according to claim 42, further comprising:
determining, by the apparatus, the dynamic score of the network entity based on at least one of a number security incidents that have happened to the network entity, a number of vulnerabilities, a number of anomalies and a number of alerts.

46. The method according to claim 42, further comprising:
determining, by the apparatus, when it is determined that an action is to performed, a timing of the action, wherein the timing of the action comprises scheduled maintenance, as soon as possible and immediate.

47. The method according to claim 42, further comprising:
changing, by the apparatus, when it is determined that an action is to be performed and the action is fix with scheduled maintenance, a configuration of the network entity;
running, by the apparatus, when it is determined that an action is to be performed and the action is fix as soon as possible, a malware and/or anti-virus program; and/or
configuring, by the apparatus, when it is determined that an action is to be performed and the action is fix immediately, a firewall of the network entity to block all traffic.

48. The method according to claim 42, further comprising:
determining, by the apparatus, that the network entity has a parent network entity in hierarchy of the network; and
determining, by the apparatus, a threat score of the parent network entity based on the threat score of the network entity.

49. The method according to claim 48, further comprising:
determining, by the apparatus, the threat score of the parent network entity as equal or bigger than the threat score of the network entity when a previous threat score of the parent network entity is lower than the threat score of the network entity.

50. A non-transitory computer readable medium having stored thereon a set of computer readable instructions that, when executed by at least one processor, cause an apparatus to at least:
determine a base score of a network entity, wherein the base score indicates importance of the network entity in a network, and the network is a core network of a cellular communication network, and the network entity is a network function;
determine a dynamic score of the network entity, wherein the dynamic score indicates at least security incidents that have happened to the network entity;
determine a threat score of the network entity based at least on the base score and the dynamic score; and
determine, based on the threat score, whether to perform an action associated with the network entity.
